(19) United States
(12) Patent Application Publication
(10) Pub. No.: US 2025/0280237 A1
(43) Pub. Date: Sep. 4, 2025

(54) AUDIO ENABLED DEVICE USING MULTIPLE ACOUSTIC PORTS

(71) Applicant: QUALCOMM Incorporated, San Diego, CA (US)

(72) Inventors: Advait Prasad KOPARKAR, Sunnyvale, CA (US); Kwokleung CHAN, Sunnyvale, CA (US); Ricardo De Jesus BERNAL CASTILLO, San Diego, CA (US); Alex TUNG, San Diego, CA (US); Nathan ALTMAN, Raanana (IL)

(21) Appl. No.: 19/044,135

(22) Filed: Feb. 3, 2025

Related U.S. Application Data
(60) Provisional application No. 63/559,835, filed on Feb. 29, 2024.

(51) Int. Cl. H04R 3/12; H04R 29/00

(52) U.S. Cl. CPC H04R 3/12; H04R 29/002; H04R 2430/01

(57) ABSTRACT

In some aspects, an audio device may measure one or more audio characteristics at one or more ears of the user. The audio device may measure one or more privacy characteristics in a privacy zone surrounding the user. The audio device may determine one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof. The audio device may optimize the audio output based on the one or more audio output metrics.

### CROSS-REFERENCE TO RELATED APPLICATIONS

The present application for patent claims the benefit of U.S. Provisional Application No. 63/559,835, entitled “AUDIO ENABLED DEVICE USING MULTIPLE ACOUSTIC PORTS,” filed Feb. 29, 2024, assigned to the assignee hereof, and expressly incorporated herein by reference in its entirety.

### BACKGROUND OF THE DISCLOSURE

### 1. Field of the Disclosure

Aspects of the disclosure relate generally to audiovisual devices.

### 2. Description of the Related Art

Audio devices have been used in public or semi-public environments which may be noisy and may not provide desired privacy. It may be desirable for a user to listen to audio without the discomfort of wearing earplugs or headsets. In some situations, it may be desirable for the user to be able to hear audio events from the surrounding environment while listening to audio from the audio device.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, a method of optimizing audio output of an audio device comprising at least two speakers worn by a user includes measuring one or more audio characteristics at one or more ears of the user; measuring one or more privacy characteristics in a privacy zone surrounding the user; determining one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and optimizing the audio output based on the one or more audio output metrics.

In some aspects, an audio device includes one or more memories; and one or more processors communicatively coupled to the one or more memories, the one or more processors, either alone or in combination, configured to: measure one or more audio characteristics at one or more ears of the user; measure one or more privacy characteristics in a privacy zone surrounding the user; determine one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and optimize the audio output based on the one or more audio output metrics.

In some aspects, an audio device includes means for measuring one or more audio characteristics at one or more ears of the user; means for measuring one or more privacy characteristics in a privacy zone surrounding the user; means for determining one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and means for optimizing the audio output based on the one or more audio output metrics.

In some aspects, a non-transitory computer-readable medium stores computer-executable instructions that, when executed by an audio device, cause the audio device to: measure one or more audio characteristics at one or more ears of the user; measure one or more privacy characteristics in a privacy zone surrounding the user; determine one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and optimize the audio output based on the one or more audio output metrics.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example user equipment (UE) architecture, according to various aspects of the disclosure.

FIGS. 2A-2H illustrate examples of audio devices according to various aspects of the disclosure.

FIG. 3 illustrates an area surrounding a user's ear which includes a desired quiet zone, also called a privacy zone or dark zone.

FIGS. 4A-4C illustrate examples of plots of measured privacy metrics over a frequency range, measured quality metrics over that frequency range, and measured metrics in polar coordinates corresponding to the quiet zone as depicted in FIG. 3.

FIG. 5 illustrates an example of using four speakers in a speaker array for one of the ears of the user in deriving the optimal audio output.

FIG. 6 illustrates an example of an OEPA algorithm.

FIG. 7 illustrates an example of an OEPA algorithm that allows for maximization of acoustic contrast while keeping other factors in check.

FIG. 8 illustrates an example graph of user or system tunable tradeoffs between key performance indicator (KPI) such as privacy, latency, power consumption, and THD.

FIGS. 9A-9C illustrate examples of quiet zones which may change depending on the presence of one or more persons detected in an area surrounding the user.

FIG. 10 illustrates an example of OEPA curves and adaptive to playback frequency.

FIG. 11 illustrates an example of OEPA being applied to only part of a playback according to aspects of the disclosure.

FIGS. 12A-12B illustrate examples of signal and noise beaming for near-field and far-field scenarios.

FIGS. 13A-13C illustrate examples of microphones that can be worn as various types of devices on a person's body.

FIG. 14 is a flowchart of an example process according to aspects of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

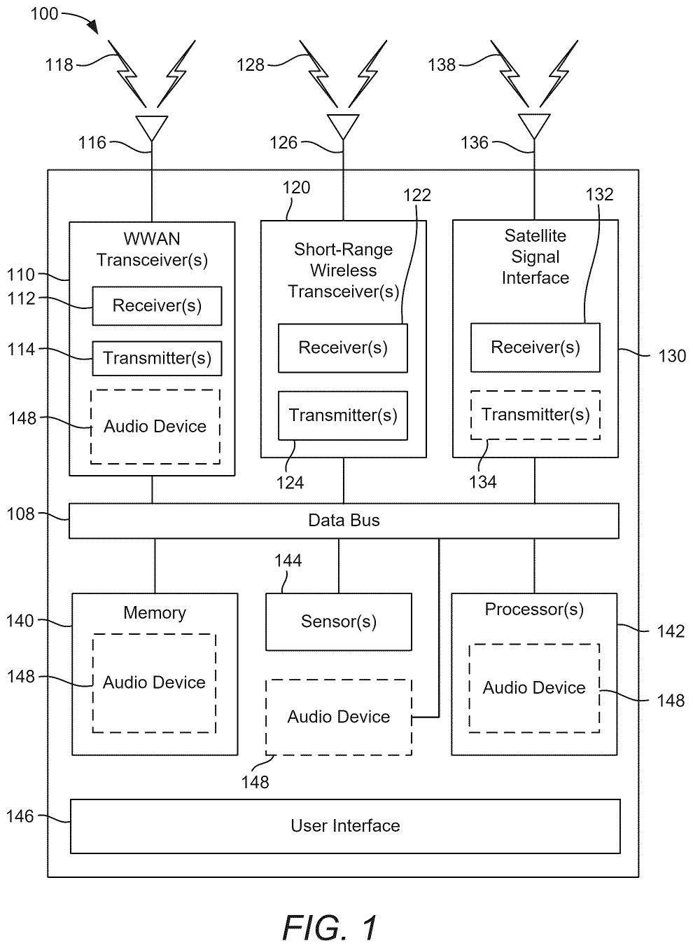

FIG. 1 illustrates several example components (represented by corresponding blocks) that may be incorporated into a mobile telephone or user equipment (UE) 100 (which may correspond to any of the UEs described herein). It will be appreciated that these components may be implemented in different types of apparatuses in different implementations (e.g., in an application-specific integrated circuit (ASIC), in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 100 includes one or more wireless wide area network (WWAN) transceivers 110 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 110 may each be connected to one or more antennas 116 for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 110 may be variously configured for transmitting and encoding signals 118 (e.g., messages, indications, information, and so on) and, conversely, for receiving and decoding signals 118 (e.g., messages, indications, information, pilots, and so on) in accordance with the designated RAT. Specifically, the one or more WWAN transceivers 110 include one or more transmitters 114 for transmitting and encoding signals 118 and one or more receivers 112 for receiving and decoding signals 118.

The UE 100 also includes, at least in some cases, one or more short-range wireless transceivers 120. The one or more short-range wireless transceivers 120 may be connected to one or more antennas 126 and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE-D, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The one or more short-range wireless transceivers 120 may be variously configured for transmitting and encoding signals 128 (e.g., messages, indications, information, and so on) and, conversely, for receiving and decoding signals 128 (e.g., messages, indications, information, pilots, and so on) in accordance with the designated RAT. Specifically, the one or more short-range wireless transceivers 120 include one or more transmitters 124 for transmitting and encoding signals 128 and one or more receivers 122 for receiving and decoding signals 128. As specific examples, the one or more short-range wireless transceivers 120 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 100 also includes, at least in some cases, a satellite signal interface 130, which includes one or more satellite signal receivers 132 and may optionally include one or more satellite signal transmitters 134. The one or more satellite signal receivers 132 may be connected to one or more antennas 136 and may provide means for receiving and/or measuring satellite positioning/communication signals 138. Where the one or more satellite signal receivers 132 include a satellite positioning system receiver, the satellite positioning/communication signals 138 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the one or more satellite signal receivers 132 include a non-terrestrial network (NTN) receiver, the satellite positioning/communication signals 138 may be communication signals (e.g., carrying control and/or user data) originating from a 5G network. The one or more satellite signal receivers 132 may comprise any suitable hardware and/or software for and receiving processing satellite positioning/communication signals 138. The one or more satellite signal receivers 132 may request information and operations as appropriate from the other systems, and, at least in some cases, perform calculations to determine locations of the UE 100 using measurements obtained by any suitable satellite positioning system algorithm.

The optional satellite signal transmitter(s) 134, when present, may be connected to the one or more antennas 136 and may provide means for transmitting satellite positioning/communication signals 138. Where the one or more satellite signal transmitters 134 include an NTN transmitter, the satellite positioning/communication signals 138 may be communication signals (e.g., carrying control and/or user data) originating from a 5G network. The one or more satellite signal transmitters 134 may comprise any suitable hardware and/or software for transmitting satellite positioning/communication signals 138. The one or more satellite signal transmitters 134 may request information and operations as appropriate from the other systems.

A transceiver may be configured to communicate over a wired or wireless link. A transceiver (whether a wired transceiver or a wireless transceiver) includes transmitter circuitry (e.g., transmitters 114, 124) and receiver circuitry (e.g., receivers 112, 122). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry (e.g., transmitters 114, 124) may include or be coupled to a plurality of antennas (e.g., antennas 116, 126), such as an antenna array, that permits the respective apparatus (e.g., UE 100) to perform transmit “beamforming,” as described herein. Similarly, wireless receiver circuitry (e.g., receivers 112, 122) may include or be coupled to a plurality of antennas (e.g., antennas 116, 126), such as an antenna array, that permits the respective apparatus (e.g., UE 100) to perform receive beamforming, as described herein. In some aspects, the transmitter circuitry and receiver circuitry may share the same plurality of antennas (e.g., antennas 116, 126), such that the respective apparatus can only receive or transmit at a given time, not both at the same time. A wireless transceiver (e.g., the one or more WWAN transceivers 110, the one or more short-range wireless transceivers 120) may also include a network listen module (NLM) or the like for performing various measurements.

As used herein, the various wireless transceivers (e.g., transceivers 110, 120) and wired transceivers may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 100) and a base station will generally relate to signaling via a wireless transceiver.

The UE 100 also includes other components that may be used in conjunction with the operations as disclosed herein. The UE 100 includes one or more processors 142 for providing functionality relating to, for example, wireless communication, and for providing other processing functionality. The one or more processors 142 may therefore provide means for processing, such as means for determining, means for calculating, means for receiving, means for transmitting, means for indicating, etc. In some aspects, the one or more processors 142 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 100 includes memory circuitry implementing memory 140 (e.g., each including a memory device) for maintaining information (e.g., information indicative of reserved resources, thresholds, parameters, and so on). The memory 140 may therefore provide means for storing, means for retrieving, means for maintaining, etc. In some cases, the UE 100 may include an audio device 148. The audio device 148 may include speakers or other types of devices that provide sound to the user. In some aspects, the audio device 148 may be integrated within or external to the mobile telephone (UE 100). The audio device 148 may be hardware circuits that are part of or coupled to the one or more processors 142 that, when executed, cause the UE 100 to perform the functionality described herein. In other aspects, the audio device 148 may be external to the processors 142 (e.g., part of a modem processing system, integrated with another processing system, etc.). Alternatively, the audio device 148 may be a memory module stored in the memory 140 that, when executed by the one or more processors 142 (or a modem processing system, another processing system, etc.), cause the UE 100 to perform the functionality described herein. FIG. 1 illustrates possible locations of the audio device 148, which may be, for example, part of the one or more WWAN transceivers 110, the memory 140, the one or more processors 142, or any combination thereof, or may be a standalone component.

The UE 100 may include one or more sensors 144 coupled to the one or more processors 142 to provide means for sensing or detecting movement and/or orientation information that is independent of motion data derived from signals received by the one or more WWAN transceivers 110, the one or more short-range wireless transceivers 120, and/or the satellite signal interface 130. By way of example, the sensor(s) 144 may include one or more accelerometers (e.g., micro-electrical mechanical systems (MEMS) devices), a gyroscope, a geomagnetic sensor (e.g., a compass), an altimeter (e.g., a barometric pressure altimeter), and/or any other type of movement detection sensor. Moreover, the sensor(s) 144 may include a plurality of different types of devices and combine their outputs in order to provide motion information. For example, the sensor(s) 144 may use a combination of a multi-axis accelerometer and orientation sensors to provide the ability to compute positions in two-dimensional (2D) and/or three-dimensional (3D) coordinate systems. Note that at least the accelerometer and gyroscope may be referred to as “inertial” sensors.

The various components of the UE 100 may be communicatively coupled to each other over a data bus 108. In some aspects, the data bus 108 may form, or be part of, a communication interface of the UE 100.

In addition, the UE 100 includes a user interface 146 providing means for providing indications (e.g., audible and/or visual indications) to a user and/or for receiving user input (e.g., upon user actuation of a sensing device such a keypad, a touch screen, a microphone, and so on).

For convenience, the UE 100 is shown in FIG. 1 as including various components that may be configured according to the various examples described herein. It will be appreciated, however, that the illustrated components may have different functionality in different designs. In particular, various components in FIG. 1 are optional in alternative configurations and the various aspects include configurations that may vary due to design choice, costs, use of the device, or other considerations. For example, a particular implementation of UE 100 may omit the WWAN transceiver(s) 110 (e.g., a wearable device or tablet computer or PC or laptop may have Wi-Fi and/or BLUEOOTH® capability without cellular capability), or may omit the short-range wireless transceiver(s) 120 (e.g., cellular-only, etc.), or may omit the satellite signal interface 130, or may omit the sensor(s) 144, and so on. For brevity, illustration of the various alternative configurations is not provided herein, but would be readily understandable to one skilled in the art.

The components of FIG. 1 may be implemented in various ways. In some implementations, the components of FIG. 1 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 110 to 146 may be implemented by processor and memory component(s) of the UE 100 (e.g., by execution of appropriate code and/or by appropriate configuration of processor components). For simplicity, various operations, acts, and/or functions are described herein as being performed “by a UE.” However, as will be appreciated, such operations, acts, and/or functions may actually be performed by specific components or combinations of components of the UE 100, such as the one or more processors 142, the one or more transceivers 110 and 120, the memory 140, the audio device 148, etc.

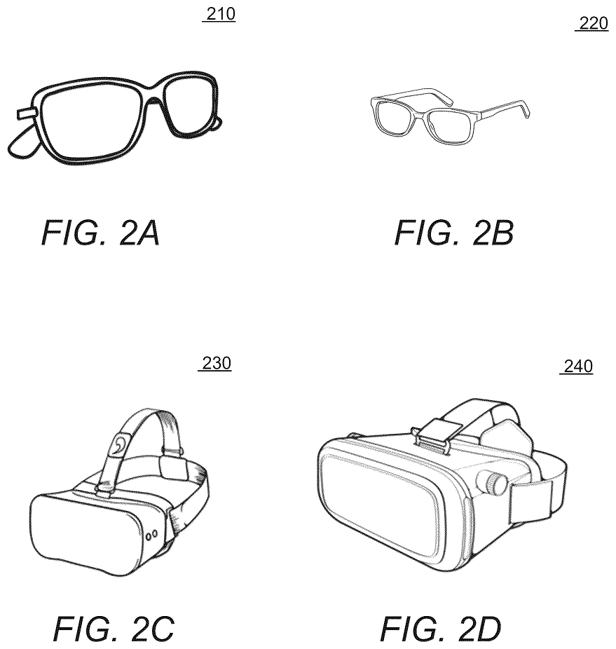

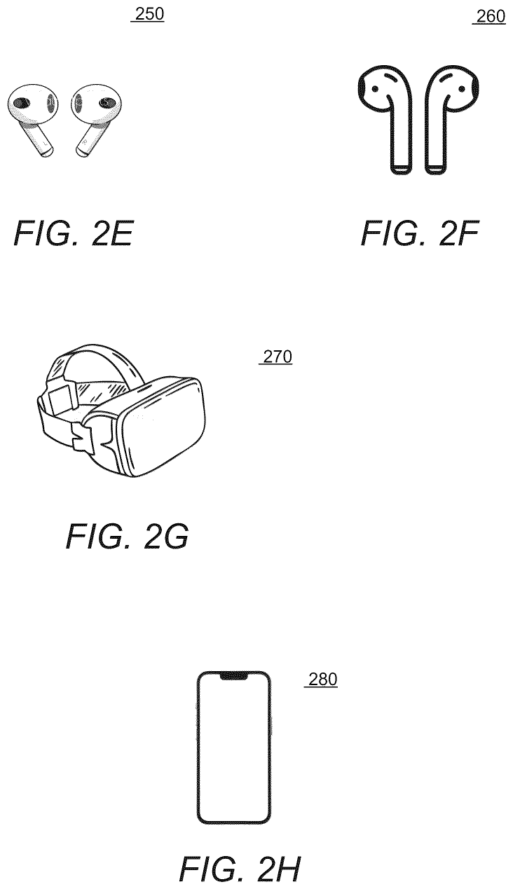

FIGS. 2A-2H illustrate examples of audio devices according to various aspects of the disclosure. Examples of audio devices according to various aspects of the disclosure may include but are not limited to augmented reality (AR) devices, virtual reality (VR) devices, smart frames, open earbuds (not directly worn on a user's ear), mobile phones, smart watches, or the like. FIGS. 2A-2B illustrate examples of smart frames 210 and 220 which have integrated speakers in the frames. FIG. 2C illustrates an example of an AR device 230 in the form of sunglasses with integrated speakers in the frame. FIG. 2D illustrates an example of a VR device 240 with integrated speakers in the VR headgear. FIGS. 2E-2F illustrate examples of open earbuds 250 and 260. FIG. 2G illustrates an example of an AR/VR device 270. FIG. 2H illustrates an example of a mobile phone 280.

According to aspects of the disclosure, a natural and comfortable way for audio consumption may be provided without the need for closed earplugs or headsets. According to aspects of the disclosure, spatial awareness is provided, and the user may interact with the surrounding environment while listening to audio content. According to aspects of the disclosure, high audio quality may be provided to the user while maintaining far-field privacy.

In some aspects, two or more speakers in a speaker array to direct audio to user and away from quiet zone. In some aspects, audio output may be optimized to minimize audio leakage, to ensure power consumption efficiency, to be robust to acoustic environment variation such as user physical size, device wearing and/or usage position, to preserve high audio quality, to maintain good aesthetic design, or a combination thereof.

In some aspects, audio devices with optimized audio output may include smart glasses or smart frames, VR devices, AR devices, open earbuds, phones, smart watches, or the like, which may play audio to open air without restriction, in contrast with restricted audio devices such as closed earplugs or headphones.

In some aspects, tradeoffs may be achieved between privacy, power, quality, latency, or other target functions. In some aspects, optimized audio output is determined based at least in part on one or more quality metrics measured at the user's ears and one or more privacy metrics measured at an area surrounding the user where other people may be located.

In some aspects, at least two speakers per ear are provided to implement a driving scheme that optimizes the relative amplitude and phase between the speakers to achieve the desired trade off.

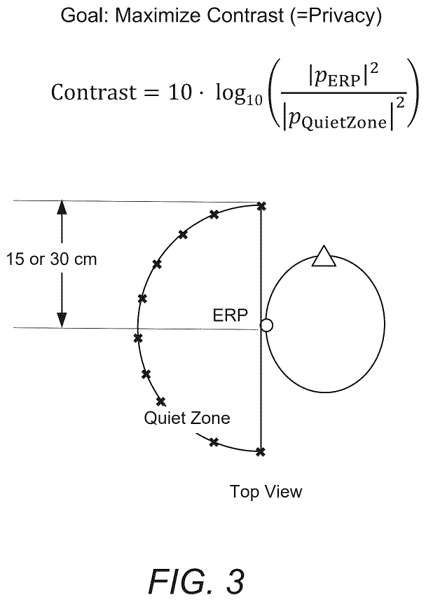

FIG. 3 illustrates an area surrounding a user's ear which includes a desired quiet zone, also called a privacy zone or dark zone. In some aspects, privacy metrics that may be considered in deriving the optimized audio output may include an attenuation in reference to the ear input at an ear reference point (ERP) in the privacy or dark zone. In some aspects, the attenuation in reference to the ear input may be measured at an arc surrounding the user and at different frequencies. For example, the arc may be defined by the boundary of the quiet zone. Other privacy metrics may be considered according to various aspects of the disclosure.

In some aspects, quality metrics that may be considered in deriving the optimized audio output may include spectrum mask flatness at the ERP with different signal levels, a total harmonic distortion (THD) at different signal levels, or any combination thereof. Other quality metrics may be considered according to various aspects of the disclosure.

In some aspects, one or more power metrics may be considered in deriving the optimized audio output. In some aspects, power metrics may include an array effort (AE), which is the total power consumed by the speakers. Other power metrics may be considered according to various aspects of the disclosure.

In some aspects, a maximum achievable volume may be considered in deriving the optimized audio output. In some aspects, a latency or finite impulse response (FIR) length may be considered in deriving the optimized audio output. One or more additional metrics may be considered in addition or as alternatives to the metrics described above in deriving the optimized audio output.

In some aspects, optimized audio output may be provided to maximize the contrast between the pressure at the ERP and the pressure at the arc defining the quiet zone to achieve the desired level of privacy for the user. For example, the contrast for privacy may be defined as:

$$Contrast = 10 \cdot {log}_{10} ( \frac{{\vert {p}_{ERP} \vert}^{2}}{{\vert {p}_{QuietZone} \vert}^{2}} )$$

where P_{ERP} is the pressure measured at the ERP, and P_{QuietZone} is the pressure measured at the arc of the quiet zone.

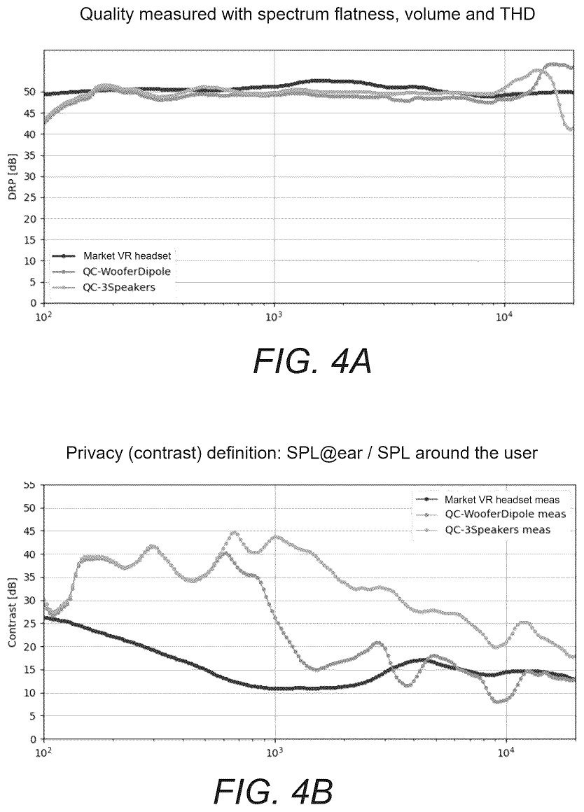

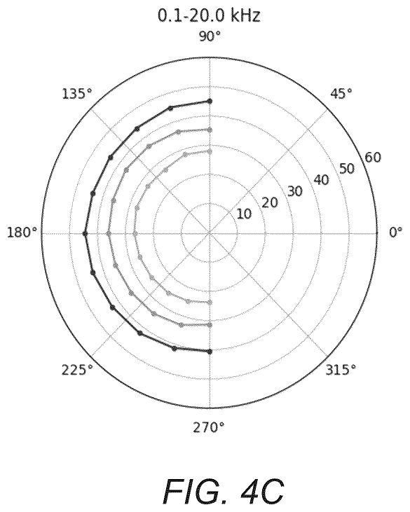

FIGS. 4A-4C illustrate examples of plots of measured privacy metrics over a frequency range, measured quality metrics over that frequency range, and measured metrics in polar coordinates corresponding to the quiet zone as depicted in FIG. 3.

In some aspects, an open ear private audio (OEPA) algorithm is provided for deriving beamforming filters for a speaker array to maximize acoustic contrast. In some aspects, a speaker array of two or more speakers is provided for each ear of the user.

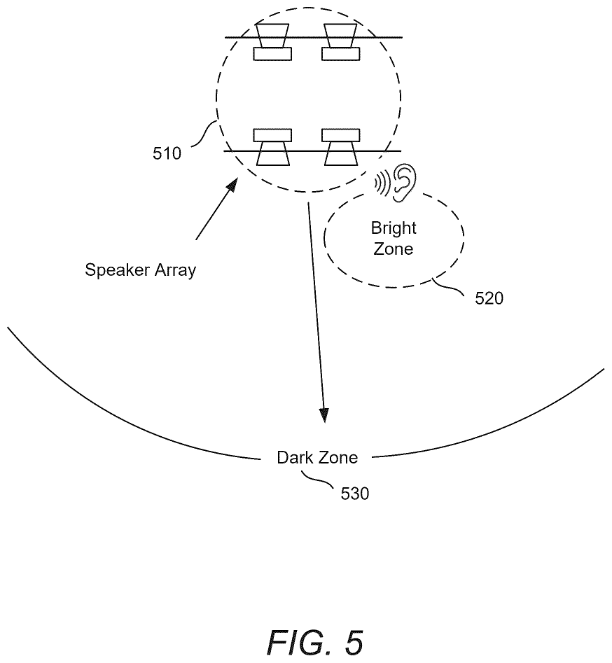

FIG. 5 illustrates an example of using four speakers in a speaker array for one of the ears of the user in deriving the optimal audio output. In the example depicted in FIG. 5, a set of four speakers in a speaker array 510 is provided to one ear of the user (for example, the left ear). The area in close proximity to the user's ear is depicted as a bright zone 520, whereas the area of quiet zone or privacy zone desired by the user is depicted as a dark zone 530.

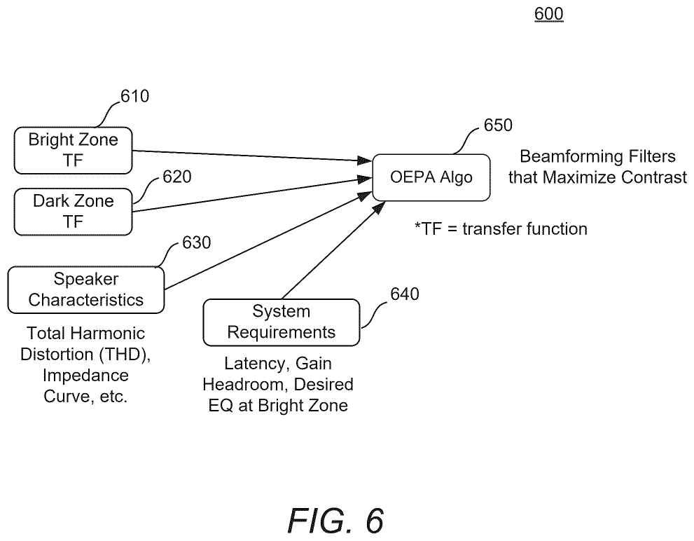

FIG. 6 illustrates an example of an OEPA algorithm 600. In some aspects, a bright zone transfer function (TF) 610 and a dark zone TF 620, speaker characteristics 630, and system requirements 640 are provided to OEPA algorithm 650. In some aspects, one or more of the bright zone TF 610 and the dark zone TF 620 may include one or more privacy metrics. In some aspects, the speaker characteristics 630 may include one or more quality metrics such as THD, impedance curve, or other metrics. In some aspects, the system requirements 640 may include latency, gain headroom, desired equalization (EQ) in the bright zone, or other metrics.

In some aspects, the OEPA algorithm 650 may generate beamforming filters for the audio device that maximizes acoustic contrast for the user. In some aspects, the OEPA algorithm 650 may be implemented to minimize the power consumed by the speaker array. In some aspects, the OEPA algorithm 650 may be implemented to improve audio quality by minimizing the THD. In some aspects, the OEPA algorithm 650 may be tuned for meeting external system requirements such as latency, desired EQ at ERP, or other system requirements.

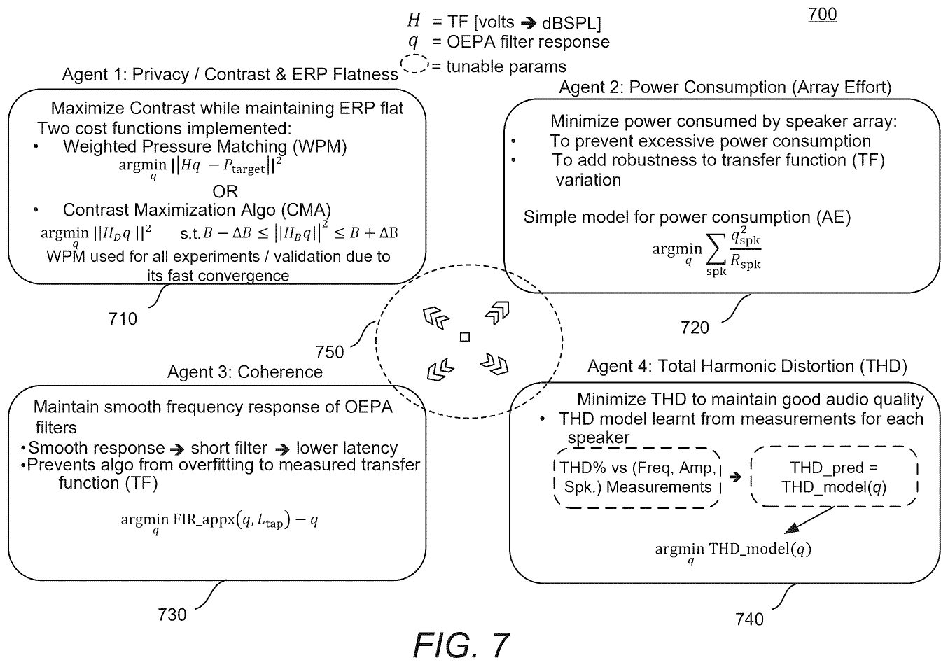

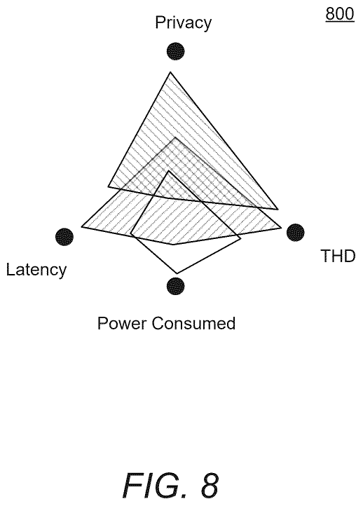

FIG. 7 illustrates an example of an OEPA algorithm 700 that allows for maximization of acoustic contrast while keeping other factors in check, that is, regularization of factors with desired tradeoffs. In some aspects, multi-agent consensus equilibrium (MACE) may be included in the OEPA algorithm which provides a framework to find an equilibrium between conflicting cost functions, also called agents.

In the example shown in FIG. 7, four types of agents including Agent 1—Privacy/Contrast & ERP Flatness 710, Agent 2—Power Consumption (Array Effort) 720, Agent 3—Coherence 730, and Agent 4—Total Harmonic Distortion (THD) 740, are considered as cost functions in the OEPA algorithm to generate maximum acoustic contrast. In some aspects, tunable parameters 750 including u Contrast from Agent 1, UAE from Agent 2, μ_{Coherence} from Agent 3, and μ_{THD} from Agent 4 are used by the OEPA algorithm to generate a maximum acoustic contrast while maintaining an equilibrium between the conflicting cost functions.

In some aspects, Agent 1 maximizes contrast while maintaining ERP flatness. In some aspects, two cost functions may be implemented:

### Weighted Pressure Matching (WPM):

$$arg {min}_{q} {‖ Hq - {P}_{target} ‖}^{2}$$

or

### Contrast Maximization Algorithm (CMA):

$$arg {min}_{q} {‖ {H}_{D} q ‖}^{2} s . t . B - Δ B \leq {‖ {H}_{B} q ‖}^{2} \leq B + Δ B$$

In some aspects, WPM may be used for all experiments and/or validation due to its fast convergence.

In some aspects, Agent 2 minimizes power consumed by the speaker array to prevent excessive power consumption, to add robustness to transfer function (TF) variation, or both. In some aspects, a simple model for power consumption (AE) is provided as follows:

$$arg {min}_{q} {\sum }_{spk} \frac{{q}_{spk}^{2}}{{R}_{spk}}$$

In some aspects, Agent 3 maintains a smooth frequency response of OEPA filters. In some aspects, a smoother response results in a short filter, which results in a lower latency. In some aspects, an algorithm is implemented to prevent the OEPA algorithm from overfitting to the measured transfer functions (TF):

$$arg {min}_{q} {FIR}_{-} appx ( q , {L}_{t a p} ) - q$$

In some aspects, Agent 4 minimizes the THD to maintain good audio quality. In some aspects, the THD model learned from the measurements for each speaker is:

$$arg {min}_{q} THD \_ model ( q )$$

FIG. 8 illustrates an example graph 800 of user or system tunable tradeoffs between key performance indicator (KPI) such as privacy, latency, power consumption, and THD. In FIG. 8, the shaded regions represent different user or system selected tunings to achieve different tradeoffs between various KPIs, at least some of which may conflict with one another in some situations.

In some aspects, the user is allowed to select and/or tune one or more KPIs of privacy, latency, THD, power consumption, or any combination thereof. In some aspects, the user may be given options to choose between high performance and battery power savings, for example.

In some aspects, the system may automatically select and/or tune one or more KPIs of privacy, latency, THD, power consumption, or any combination thereof. In some aspects, the system may enter a low-power mode when the device battery is low, for example. In some aspects, the system may choose between high performance and low latency depending on the types of use cases such voice call, video call, music playback, gaming, or the like.

In some aspects, adaptive OEPA may be provided to account for variations in the desired quiet zone. In some aspects, adaptive OEPA may be provided based on spatial location. For example, the OEPA algorithm may be adapted for spatial location based on the use of modalities such as a camera, a gyroscope, ultrasound, a user selectable input, or any combination thereof, to specify the quiet zone.

In some aspects, the OEPA algorithm may be adapted for spatial location by using a camera that detects people in an area surrounding the user, for example. In some aspects, the OEPA algorithm may be adapted for spatial location by using a microphone array that detects people in a surrounding area, for example. In some aspects, the OEPA algorithm may be adapted for spatial location by using an ultrasound that detects people in a surrounding area, for example.

In some aspects, the OEPA algorithm may be adapted for spatial location by using a gyroscope that adjusts the quiet beam, that is, a beam defined by a sector of a quiet zone when the user's head is tilted.

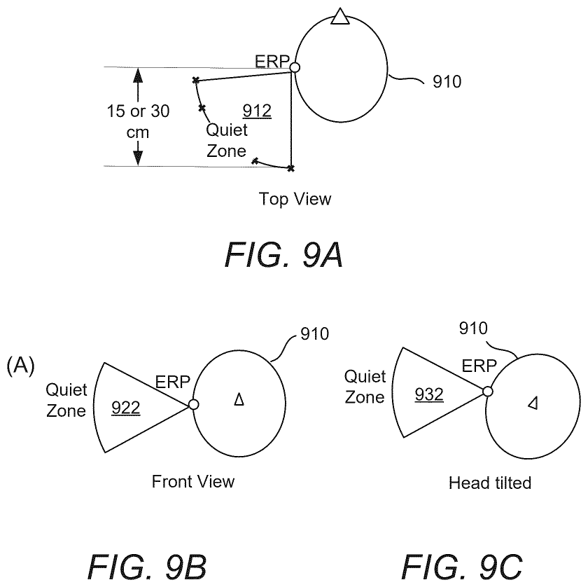

FIGS. 9A-9C illustrate examples of quiet zones which may change depending on the presence of one or more persons detected in an area surrounding the user. In the example shown in FIG. 9A, a quiet zone 912 which is a sector extending from an ear reference point (ERP) of the user's head 910 may include an area behind the head 910. In the example shown in FIG. 9B, a quiet zone 922 is depicted as a sector extending from the ERP when the head 910 is in an upright position. In the example shown in FIG. 9C, a quiet zone 932 is depicted as a sector extending from the ERP that is somewhat behind the head 910 when the head 910 is in a tilted position. With adaptive OEPA, the quiet zone may be dynamically adjusted by using one or more of the modalities such as a camera, a microphone array, an ultrasound, a gyroscope, a user selectable input, or any combination thereof.

In some aspects, an adaptive OEPA algorithm may combine multiple modalities as scene selection, for example, on a street, in an automobile, or in another environment. In some aspects, the user may select the desired quiet zone. For example, the user may select the desired quiet zone to be at front, side, or back of the head. In some aspects, the adaptive OEPA algorithm may adjust the OEPA filter and the signal into individual speakers to achieve cancellation of audio signal at the targeted quiet zone.

In some aspects, an adaptive OEPA algorithm may adapt the frequency content to the type of sound. For example, the adaptive OEPA algorithm may adapt the frequency content to prevent leaking of speech signals, to optimize for a specific playback, or a combination thereof.

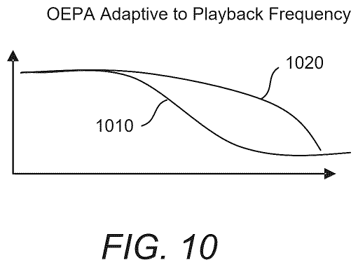

FIG. 10 illustrates an example of OEPA curves 1010 and 1020 adaptive to playback frequency. In FIG. 10, curve 1010 is an example of a low-frequency playback, such as speech, which typically has a relatively large low-frequency content and a relatively small high-frequency content. In some aspects, OEPA tuning may be changed or adapted to maximize privacy at low frequencies. FIG. 10 also shows a curve 1020 which is an example of a high-frequency playback, such as electronic music, which typically has audio content over a broader spectrum. In some aspects, OEPA tuning may be changed or adapted to cover a broader spectrum for high-frequency playback.

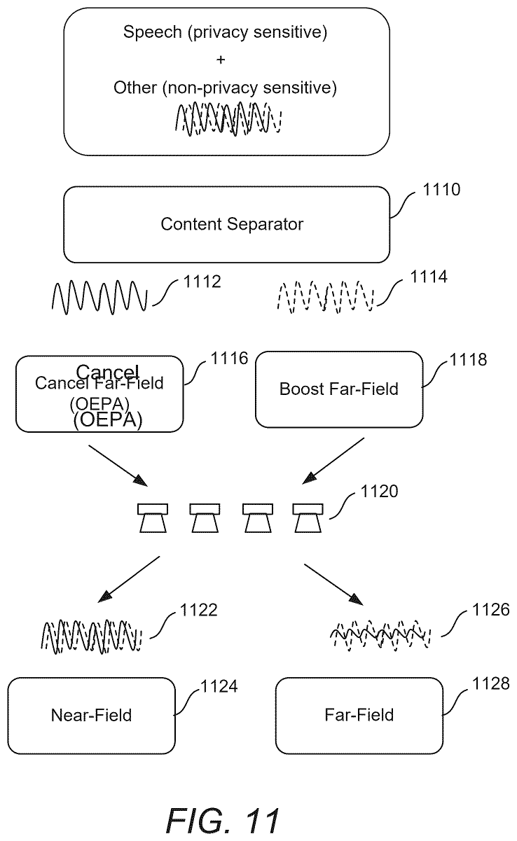

FIG. 11 illustrates an example of OEPA being applied to only part of a playback according to aspects of the disclosure. In FIG. 11, the playback includes both speech (which is privacy sensitive) and non-speech (which is not privacy sensitive). In some aspects, a content separator 1110 is provided in the OEPA algorithm to separate the speech content from the non-speech content. In some aspects, the speech content represented by signal 1112 is separated from non-speech content represented by signal 1114.

In some aspects, in order to preserve privacy, that is, to prevent speech content from being audible in the far field, an operation is performed by the OEPA to cancel the speech content in the far field (block 1116). In some aspects, an operation is performed by the OEPA to boost non-speech content in the far field (block 1118). The cancellation of speech content in the far field and the boosting of non-speech content are provided to speaker array 1120. The audio signals generated by the speaker array 1120 include both speech and non-speech signals 1122 in the near field 1124, and boosted non-speech signals and canceled or attenuated speech signals 1126 in the far field 1128.

In some aspects, the OEPA algorithm may include operations to mask sound with noise at far field to preserve privacy. In some aspects, the OEPA algorithm may inject and direct noise signal to far field, such that far-field leakage of speech signals is masked by the injected noise. In some aspects, injected noise may be desirable when the user is in a noisy environment and needs to turn up the volume of the audio device.

In some aspects, noise injection to the far field may be less intrusive to people around as they are already in a noisy environment. In some aspects, noise content may be adjusted and shaped to mimic or simulate environmental noise. In some aspects, far-field noise injection without affecting the ERP may be assisted by placing one or more speakers farther away from the ERP.

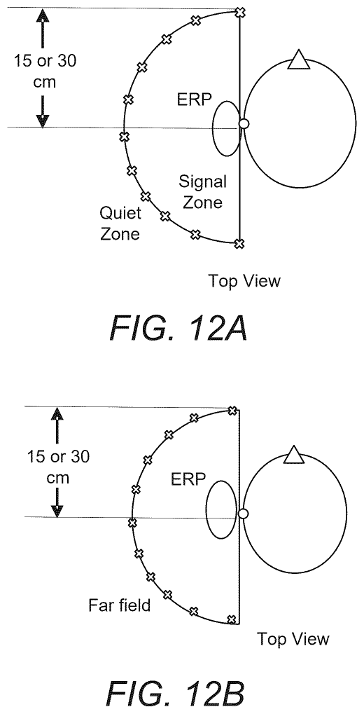

FIGS. 12A-12B illustrate examples of signal and noise beaming for near-field and far-field scenarios. FIG. 12A illustrates an example of a desired signal, such as a speech signal, beamed to the ERP away from the quiet zone. FIG. 12B illustrates an example of noise signals beamed to the far field away from the ERP.

In some aspects, the OEPA algorithm may include adaptive OEPA which allows calibration of filters every time a user wears the audio device. In some aspects, a calibration graphic user interface (GUI) may be provided to the user. In some aspects, one or more transfer functions from the speakers to the user may be captured to optimize the OEPA filter. In some aspects, the adaptive OEPA algorithm may continuously use microphones on the device to monitor playback and leakage signals.

In some aspects, the adaptive OEPA algorithm may use one or more microphones on a wearable device to calibrate amplitude and/or phase of the speakers. In some aspects, adaptive filters may be implemented based on feedback from one or more microphones on a headset, a watch, a phone, or the like.

In some aspects, optimal filters may be switched or tuned according to the audio content, such as speech, music, or other types of audio content, from one or more microphones.

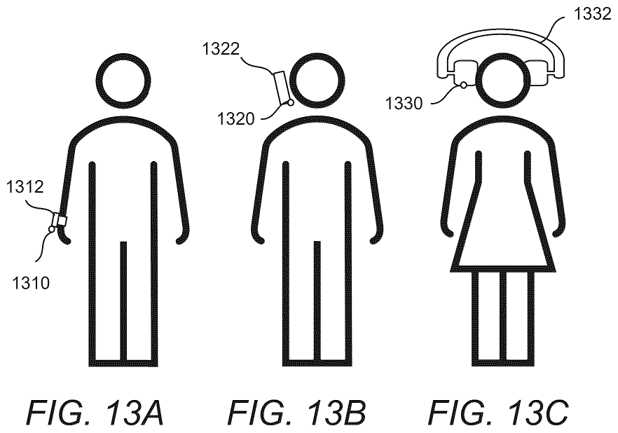

FIGS. 13A-13C illustrate examples of microphones that can be worn as various types of devices on a person's body. FIG. 13A illustrates an example of a microphone 1310 on a smart watch 1312. FIG. 13B illustrates an example of a microphone 1320 on a phone 1322. FIG. 13C illustrates an example of a microphone 1330 on a headset 1332. One or more microphones may be provided in various manners for the OEPA algorithm to calibrate filters for optimal audio feedback according to aspects of the disclosure.

In some aspects, cavity design may be optimized for privacy, audio quality, robustness, or any combination thereof, with finite element method (FEM) and/or boundary element method (BEM) simulations. In some aspects, geometry of port locations may be optimized with FEM and/or BEM simulations. In some aspects, two speakers may be used as a single dipole to save amplifier component. In some aspects, speaker evaluation and/or ranking method may be provided from the perspective of OEPA.

In some aspects, measurements and/or tuning procedures may be provided to achieve open ear private audio. In some aspects, FEM and/or BEM may be used to simulate TFs and/or OEPA to verify a number of audio device candidates. In some aspects, the number of candidates may be narrowed down to a few candidates. In some aspects, once a few candidates are selected, 3D printed models of the candidates may be printed, TF measurements may be made, the TF measurements may be feed into the OEPA algorithm, and the candidate audio devices may then go through hardware verification.

In some aspects, one or more add-on speakers may be attached to the audio device for increased privacy. In some aspects, per-unit factory calibration of relative amplitude and phase may be performed. In some aspects, dipoles may be used for one or more of the speakers.

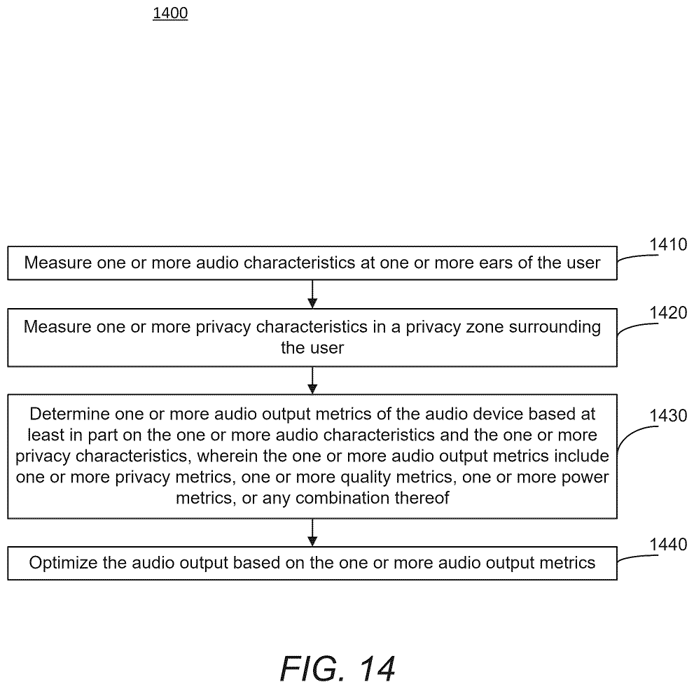

FIG. 14 is a flowchart of an example process 1400 associated with audio enabled device using multiple acoustic ports. In some implementations, one or more process blocks of FIG. 14 may be performed by an audio device (e.g., audio device 148). In some implementations, one or more process blocks of FIG. 14 may be performed by another device or a group of devices separate from or including the audio device. Additionally, or alternatively, one or more process blocks of FIG. 14 may be performed by one or more components of the device, such as one or more processors 142, memory 140, one or more sensors 144, user interface 146, and/or data bus 108.

As shown in FIG. 14, process 1400 may include measuring one or more audio characteristics at one or more ears of the user (block 1410).

As further shown in FIG. 14, process 1400 may include measuring one or more privacy characteristics in a privacy zone surrounding the user (block 1420).

As further shown in FIG. 14, process 1400 may include determining one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof (block 1430).

As further shown in FIG. 14, process 1400 may include optimizing the audio output based on the one or more audio output metrics (block 1440).

Process 1400 may include additional implementations, such as any single implementation or any combination of implementations described below and/or in connection with one or more other processes described elsewhere herein.

In a first implementation, process 1400 includes determining a relative amplitude, a relative phase, or any combination thereof, between the at least two speakers.

In a second implementation, the one or more audio output metrics are determined based at least in part on the relative amplitude, the relative phase, or any combination thereof.

In a third implementation, the one or more privacy metrics include an attenuation in reference to an ear input signal level in the privacy zone.

In a fourth implementation, the privacy zone is a zone in proximity to the user.

In a fifth implementation, the one or more privacy metrics are measured at a plurality of audio frequencies.

In a sixth implementation, the one or more quality metrics include spectrum mask flatness at an ear reference point (ERP) at a plurality of signal levels.

In a seventh implementation, the one or more quality metrics include total harmonic distortion (THD) at a plurality of signal levels.

In an eighth implementation, process 1400 includes measuring one or more speaker characteristics.

In a ninth implementation, process 1400 includes performing one or more beamforming operations for the at least two speakers to increase acoustic contrast.

Although FIG. 14 shows example blocks of process 1400, in some implementations, process 1400 may include additional blocks, fewer blocks, different blocks, or differently arranged blocks than those depicted in FIG. 14. Additionally, or alternatively, two or more of the blocks of process 1400 may be performed in parallel.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of optimizing audio output of an audio device comprising at least two speakers worn by a user, comprising: measuring one or more audio characteristics at one or more ears of the user; measuring one or more privacy characteristics in a privacy zone surrounding the user; determining one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and optimizing the audio output based on the one or more audio output metrics.

Clause 2. The method of clause 1, further comprising determining a relative amplitude, a relative phase, or any combination thereof, between the at least two speakers.

Clause 3. The method of clause 2, wherein the one or more audio output metrics are determined based at least in part on the relative amplitude, the relative phase, or any combination thereof.

Clause 4. The method of any of clauses 1 to 3, wherein the one or more privacy metrics include an attenuation in reference to an ear input signal level in the privacy zone.

Clause 5. The method of any of clauses 1 to 4, wherein the privacy zone is a zone in proximity to the user.

Clause 6. The method of any of clauses 1 to 5, wherein the one or more privacy metrics are measured at a plurality of audio frequencies.

Clause 7. The method of any of clauses 1 to 6, wherein the one or more quality metrics include spectrum mask flatness at an ear reference point (ERP) at a plurality of signal levels.

Clause 8. The method of any of clauses 1 to 7, wherein the one or more quality metrics include total harmonic distortion (THD) at a plurality of signal levels.

Clause 9. The method of any of clauses 1 to 8, further comprising measuring one or more speaker characteristics.

Clause 10. The method of any of clauses 1 to 9, further comprising performing one or more beamforming operations for the at least two speakers to increase acoustic contrast.

Clause 11. An audio device, comprising: one or more memories; and one or more processors communicatively coupled to the one or more memories, the one or more processors, either alone or in combination, configured to: measure one or more audio characteristics at one or more ears of the user; measure one or more privacy characteristics in a privacy zone surrounding the user; determine one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and optimize the audio output based on the one or more audio output metrics.

Clause 12. The audio device of clause 11, wherein the one or more processors, either alone or in combination, are further configured to determine a relative amplitude, a relative phase, or any combination thereof, between the at least two speakers.

Clause 13. The audio device of clause 12, wherein the one or more audio output metrics are determined based at least in part on the relative amplitude, the relative phase, or any combination thereof.

Clause 14. The audio device of any of clauses 11 to 13, wherein the one or more privacy metrics include an attenuation in reference to an ear input signal level in the privacy zone.

Clause 15. The audio device of any of clauses 11 to 14, wherein the privacy zone is a zone in proximity to the user.

Clause 16. The audio device of any of clauses 11 to 15, wherein the one or more privacy metrics are measured at a plurality of audio frequencies.

Clause 17. The audio device of any of clauses 11 to 16, wherein the one or more quality metrics include spectrum mask flatness at an ear reference point (ERP) at a plurality of signal levels.

Clause 18. The audio device of any of clauses 11 to 17, wherein the one or more quality metrics include total harmonic distortion (THD) at a plurality of signal levels.

Clause 19. The audio device of any of clauses 11 to 18, wherein the one or more processors, either alone or in combination, are further configured to measure one or more speaker characteristics.

Clause 20. The audio device of any of clauses 11 to 19, wherein the one or more processors, either alone or in combination, are further configured to perform one or more beamforming operations for the at least two speakers to increase acoustic contrast.

Clause 21. An audio device, comprising: means for measuring one or more audio characteristics at one or more ears of the user; means for measuring one or more privacy characteristics in a privacy zone surrounding the user; means for determining one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and means for optimizing the audio output based on the one or more audio output metrics.

Clause 22. The audio device of clause 21, further comprising means for determining a relative amplitude, a relative phase, or any combination thereof, between the at least two speakers.

Clause 23. The audio device of clause 22, wherein the one or more audio output metrics are determined based at least in part on the relative amplitude, the relative phase, or any combination thereof.

Clause 24. The audio device of any of clauses 21 to 23, wherein the one or more privacy metrics include an attenuation in reference to an ear input signal level in the privacy zone.

Clause 25. The audio device of any of clauses 21 to 24, wherein the privacy zone is a zone in proximity to the user.

Clause 26. The audio device of any of clauses 21 to 25, wherein the one or more privacy metrics are measured at a plurality of audio frequencies.

Clause 27. The audio device of any of clauses 21 to 26, wherein the one or more quality metrics include spectrum mask flatness at an ear reference point (ERP) at a plurality of signal levels.

Clause 28. The audio device of any of clauses 21 to 27, wherein the one or more quality metrics include total harmonic distortion (THD) at a plurality of signal levels.

Clause 29. The audio device of any of clauses 21 to 28, further comprising means for measuring one or more speaker characteristics.

Clause 30. The audio device of any of clauses 21 to 29, further comprising means for performing one or more beamforming operations for the at least two speakers to increase acoustic contrast.

Clause 31. A non-transitory computer-readable medium stores computer-executable instructions that, when executed by an audio device, cause the audio device to: measure one or more audio characteristics at one or more ears of the user; measure one or more privacy characteristics in a privacy zone surrounding the user; determine one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and optimize the audio output based on the one or more audio output metrics.

Clause 32. The non-transitory computer-readable medium of clause 31, further comprising computer-executable instructions that, when executed by the audio device, cause the audio device to determine a relative amplitude, a relative phase, or any combination thereof, between the at least two speakers.

Clause 33. The non-transitory computer-readable medium of clause 32, wherein the one or more audio output metrics are determined based at least in part on the relative amplitude, the relative phase, or any combination thereof.

Clause 34. The non-transitory computer-readable medium of any of clauses 31 to 33, wherein the one or more privacy metrics include an attenuation in reference to an ear input signal level in the privacy zone.

Clause 35. The non-transitory computer-readable medium of any of clauses 31 to 34, wherein the privacy zone is a zone in proximity to the user.

Clause 36. The non-transitory computer-readable medium of any of clauses 31 to 35, wherein the one or more privacy metrics are measured at a plurality of audio frequencies.

Clause 37. The non-transitory computer-readable medium of any of clauses 31 to 36, wherein the one or more quality metrics include spectrum mask flatness at an ear reference point (ERP) at a plurality of signal levels.

Clause 38. The non-transitory computer-readable medium of any of clauses 31 to 37, wherein the one or more quality metrics include total harmonic distortion (THD) at a plurality of signal levels.

Clause 39. The non-transitory computer-readable medium of any of clauses 31 to 38, further comprising computer-executable instructions that, when executed by the audio device, cause the audio device to measure one or more speaker characteristics.

Clause 40. The non-transitory computer-readable medium of any of clauses 31 to 39, further comprising computer-executable instructions that, when executed by the audio device, cause the audio device to perform one or more beamforming operations for the at least two speakers to increase acoustic contrast.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. An audio device, comprising:
at least two speakers;
one or more memories; and
one or more processors communicatively coupled to the one or more memories, the one or more processors, either alone or in combination, configured to:
measure one or more audio characteristics at one or more ears of a user;
measure one or more privacy characteristics in a privacy zone surrounding the user;
determine one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and
optimize an audio output based on the one or more audio output metrics.

2. The audio device of claim 1, wherein the one or more processors, either alone or in combination, are further configured to determine a relative amplitude, a relative phase, or any combination thereof, between the at least two speakers.

3. The audio device of claim 2, wherein the one or more audio output metrics are determined based at least in part on the relative amplitude, the relative phase, or any combination thereof.

4. The audio device of claim 1, wherein the one or more privacy metrics include an attenuation in reference to an ear input signal level in the privacy zone.

5. The audio device of claim 1, wherein the privacy zone is a zone in proximity to the user.

6. The audio device of claim 1, wherein the one or more privacy metrics are measured at a plurality of audio frequencies.

7. The audio device of claim 1, wherein the one or more quality metrics include spectrum mask flatness at an ear reference point (ERP) at a plurality of signal levels.

8. The audio device of claim 1, wherein the one or more quality metrics include total harmonic distortion (THD) at a plurality of signal levels.

9. The audio device of claim 1, wherein the one or more processors, either alone or in combination, are further configured to measure one or more speaker characteristics.

10. The audio device of claim 1, wherein the one or more processors, either alone or in combination, are further configured to perform one or more beamforming operations for the at least two speakers to increase acoustic contrast.

11. A method of optimizing audio output of an audio device comprising at least two speakers worn by a user, comprising:
measuring one or more audio characteristics at one or more ears of the user;
measuring one or more privacy characteristics in a privacy zone surrounding the user;
determining one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and
optimizing the audio output based on the one or more audio output metrics.

12. The method of claim 11, further comprising determining a relative amplitude, a relative phase, or any combination thereof, between the at least two speakers.

13. The method of claim 12, wherein the one or more audio output metrics are determined based at least in part on the relative amplitude, the relative phase, or any combination thereof.

14. The method of claim 11, wherein the one or more privacy metrics include an attenuation in reference to an ear input signal level in the privacy zone.

15. The method of claim 11, wherein the privacy zone is a zone in proximity to the user.

16. A non-transitory computer-readable medium storing computer-executable instructions that, when executed by an audio device, cause the audio device to:
measure one or more audio characteristics at one or more ears of a user;
measure one or more privacy characteristics in a privacy zone surrounding the user;
determine one or more audio output metrics of the audio device based at least in part on the one or more audio characteristics and the one or more privacy characteristics, wherein the one or more audio output metrics include one or more privacy metrics, one or more quality metrics, one or more power metrics, or any combination thereof; and
optimize an audio output based on the one or more audio output metrics.

17. The non-transitory computer-readable medium of claim 16, further comprising computer-executable instructions that, when executed by the audio device, cause the audio device to determine a relative amplitude, a relative phase, or any combination thereof, between at least two speakers.

18. The non-transitory computer-readable medium of claim 17, wherein the one or more audio output metrics are determined based at least in part on the relative amplitude, the relative phase, or any combination thereof.

19. The non-transitory computer-readable medium of claim 16, wherein the one or more privacy metrics include an attenuation in reference to an ear input signal level in the privacy zone.

20. The non-transitory computer-readable medium of claim 16, wherein the privacy zone is a zone in proximity to the user.
